(19) United States
(12) Patent Application Publication
(10) Pub. No.: US 2009/0261592 A1
(43) Pub. Date: Oct. 22, 2009

(54) Solar Energy Conversion Using Brayton System

(76) Inventor: Thomas P. Kay, Woodstock, NY (US)

Correspondence Address: LEVINE & MANDELBAUM, 222 Bloomingdale Road, Suite 203, WHITE PLAINS, NY, 10605, US

(21) Appl. No.: 12/422,444

(22) Filed: Apr. 13, 2009

Related U.S. Application Data
(60) Provisional application No. 61/045,427, filed on Apr. 16, 2008.

(51) Int. Cl. H02K 7/18; F03G 6/06

(52) U.S. Cl. 290/52; 60/641.15

(57) ABSTRACT

A modified Brayton Cycle Engine employs solar radiation to heat a compressible Brayton working fluid for driving a turbine to which an electric generator is coupled for converting solar radiation to electricity. A compressor, also coupled to the turbine, compresses the Brayton working fluid before it is heated by the solar radiation. Heat from a solar MHD generator may also be used to heat the Brayton working fluid. A heat pipe can be used to efficiently transfer heat from the solar radiation or MHD generator to the Brayton working fluid. Spent Brayton working fluid exiting the turbine is passed through a heat exchanger to preheat compressed Brayton working fluid exiting the compressor before the compressed Brayton working fluid is heated by the solar radiation. The spent Brayton working fluid exiting the heat exchanger may be further cooled in another heat exchanger across which ambient air can be blown.

### BACKGROUND OF THE INVENTION

This invention relates to conversion of solar energy to electrical energy, and more particularly to such conversion using a Brayton cycle system.

A Brayton cycle engine traditionally includes three basic components, namely, a compressor, a combustor, and a turbine, the compressor and the turbine being mounted on the same shaft. Air compressed by the compressor is mixed with fuel and burned in the combustor. Hot gas from the combustor drives the turbine which in turn operates the compressor. Excess energy not needed to rotate the compressor is available to drive a generator or alternator so as to create electrical energy.

### SUMMARY OF THE INVENTION

According to the present invention, the combustor is eliminated, and solar energy from a collector is transmitted to the Brayton working fluid of the Brayton cycle engine so as to heat the fluid at a point upstream of the turbine. The invention also contemplates an arrangement in which solar radiation is used to heat the working fluid of a magnetohydrodynamic (MHD) energy conversion device, and heat from the MHD working fluid is transmitted to the working fluid of the Brayton cycle system.

### DESCRIPTION OF THE DRAWINGS

The invention will be described in more detail with reference to the accompanying drawings, in which:

FIG. 1 is a schematic diagram of a solar energy conversion arrangement using a Brayton cycle system; and

FIG. 2 is a schematic diagram similar to FIG. 1, illustrating a system incorporating a magnetohydrodynamic energy conversion device.

### DESCRIPTION OF THE PREFERRED EMBODIMENT

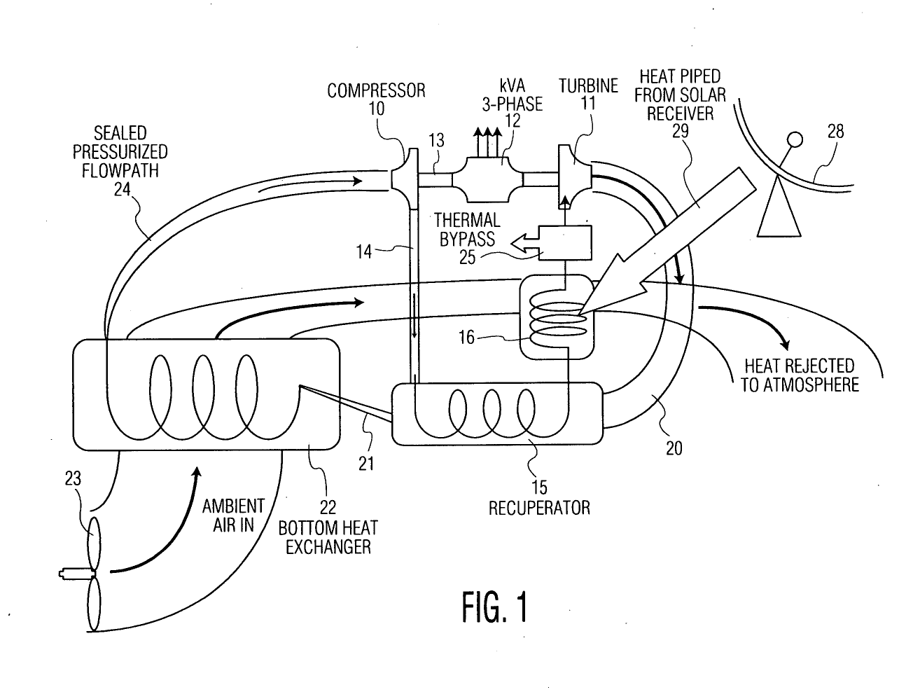

Referring to FIG. 1, a Brayton cycle engine according to the present invention includes a compressor 10 having a working fluid input and a working fluid output and a turbine 11 in circuit with a heat exchanger, or recuperator 15, said turbine having a working fluid input and a working fluid output and a heater 16. An electrical generator or alternator 12 is also provided, and preferably, the compressor, turbine, and alternator are all mounted on a single shaft 13.

Compressed Brayton working fluid leaving compressor 10 is ducted by conduit 14 to recuperator 15 from which the Brayton working fluid is further ducted to heater 16, from which point the compressed and heated Brayton working fluid flows to the turbine 11 to drive the latter. Rotation of turbine 11 serves, via shaft 13, to drive compressor 10 as well as alternator 12. The alternator may be one which produces three-phase, alternating electric current. The Brayton Brayton working fluid is preferably a gas, or mixture of gases, calculated to optimize operation of the turbine. Among the gases suitable for the purpose are argon, carbon dioxide, nitrogen, helium, xenon, and krypton.

The reduced temperature, but still hot, Brayton Brayton working fluid leaving turbine 11 flows through conduit 20 to recuperator 15, wherein it serves to pre-heat the compressed Brayton working fluid flowing to the recuperator through conduit 14. The post-turbine fluid then flows from recuperator 15 through a conduit 21 to a heat exchanger 22 which also receives ambient air from a fan 23. In this way, the post-turbine Brayton working fluid is further cooled before it continues its flow through a conduit 24 back to the inlet of compressor 10. The heat picked up by ambient air from fan 23 is dispensed to the atmosphere, or possibly used to heat other components.

A thermal bypass loop 25 may be interposed between the heater 16 and turbine 11 to limit the temperature of the Brayton working fluid entering the turbine. The loop contains a relatively cool gas which is metered into the Brayton Brayton working fluid through a valve controlled by a temperature sensor, such as a thermocouple. In this way, should the Brayton working fluid reach an excessive temperature, the metered fluid mixing with it will bring the temperature of the Brayton working fluid down to an acceptable limit.

The Brayton cycle Brayton working fluid is heated in heater 16 by means of solar radiation. This may be accomplished by using a parabolic solar collector or receiver 28, or an array of such collectors, capable of concentrating the rays of the sun at the focus or focal point of the collector. The solar heat is then transmitted from the solar collector to the Brayton cycle Brayton working fluid in heater 16. A preferred approach to transmitting the solar heat to the Brayton working fluid is to use a heat pipe, or a bundle of two or more heat pipes, such as that made by Thermal Transtech International Corporation of Taipei, Taiwan.

A heat pipe, schematically illustrated at 29, is a sealed hollow tube containing a wicking material and an evaporable liquid. For the purposes of this invention the tube is preferably of a heat resistant material, such as a ceramic or carbon fibers, and the liquid within could be a high boiling point metal such as silver or lithium. Thermal energy is very efficiently transmitted from one end of the heat pipe to the other. Therefore, a heat pipe could be arranged to pass through the wall of the heater housing or coil containing the Brayton working fluid. One end of the heat pipe can be arranged to be heated by a parabolic reflector, such as by being located at the focus of the reflector, and the other end reaching temperatures of approximately 1,700-1,800 degrees Celsius, being in contact with the Brayton working fluid within the healer 16. In this way, the solar energy is used to efficiently heat the Brayton Brayton working fluid. An advantage of using a heat pipe in this way is that a heat pipe transfers heat in only one direction, i.e., from the reflector to the Brayton working fluid container. Multiple parabolic reflectors, each including a heat pipe or pipes, could be used to heat the Brayton working fluid in the heater. Some heat pipes are flexible, which may aid this arrangement, as well as in combination with sun-tracking reflectors. Since heat pipes lose efficiency as they increase in length, the shortest possible heat pipe should be used, even as short as one foot in length.

In order to increase the efficiency of heat transfer from the heat pipe to the Brayton Brayton working fluid, the end of the heat pipe contacting the fluid may be furnished with pin-fins, such as illustrated in U.S. Pat. No. 6,817,405. In place of the parabolic solar dish collector 28, a parabolic trough solar collector could be employed. A trough solar collector is an elongated shell having a parabolic cross-sectional shape. A conduit extends along the focus of the parabolic trough, and for the sake of efficiency the conduit is encased within an evacuated glass tube. The conduit at the focus of the parabolic trough may replace the heater 16. In this case, the compressed Brayton working fluid leaving recuperator 15 flows through the conduit of the trough solar collector, wherein the Brayton working fluid is heated, the fluid then being ducted to turbine 11.

It may be desirable to provide the conduit with fins, or honeycombs or an accordion shape to work as heat trap structures to increase the temperature of the Brayton working fluid in the conduit pipe. This “heat trap” captures the solar radiation more efficiently and causes the solar radiation to be trapped inside and not be re radiated or reflected (bounced) out, therefore increasing the temperature of the Brayton working fluid. Whereas state of the art solar trough collectors currently use black selective paint or coating to increase efficiencies, at this time these black paints or selective coatings break down at high temperatures and cannot sustain the higher temperature desired in this application or configuration.

It is contemplated that a conduit could be used to guide the Brayton working fluid from the recuperator 15 to the focus of the parabolic solar collector 28 and then on to the turbine 11, thereby replacing the heater 16.

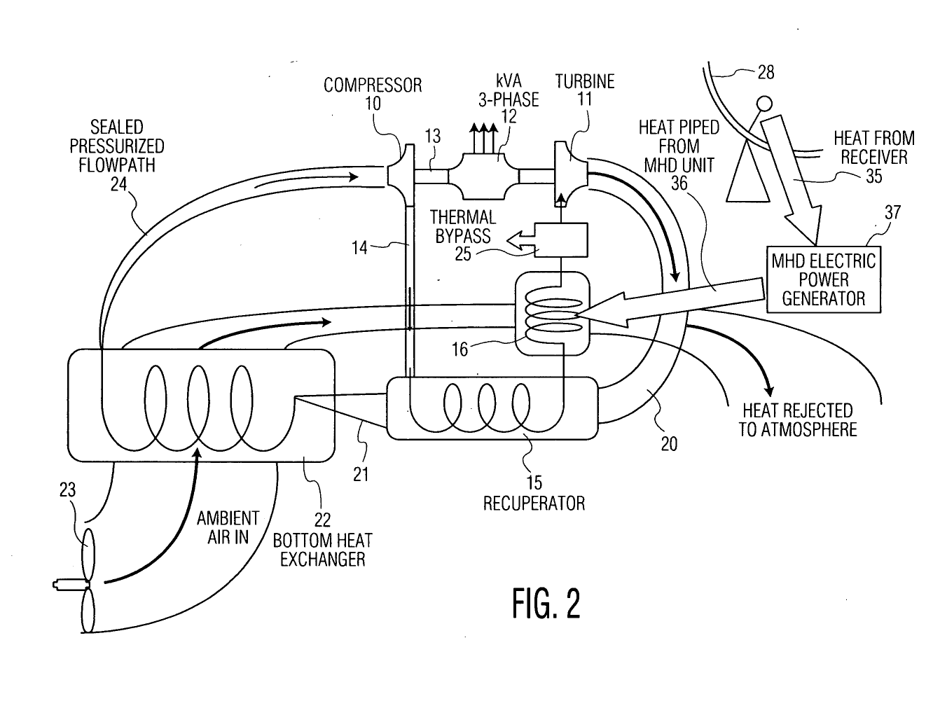

FIG. 2 illustrates a system similar to that shown in FIG. 1, except that it is used in combination with a conventional magnetohydrodynamic solar/electrical energy conversion system 37. This type of system is known (see for example U.S. Pat. No. 4,275,318), and may include a container accommodating a magnetohydrodynamic working fluid which is heated, such as by solar radiation captured by a solar collector 28. The solar heat may be transmitted by a heat pipe or pipes 35 to the MHD container in order to ionize the MHD working fluid in the container.

An MHD electrode system includes, as usual, a nonelectrically-conductive enclosure through which the ionized Brayton working fluid flows, and a nozzle at one end for introducing the ionized plasma into the enclosure. The pressure of the Brayton working fluid is preferably sufficient to create a supersonic flow through the nozzle, since the faster the flow the more efficiently electricity is produced. Magnets, which are preferably super conductive magnets, extend along the length of the enclosure to create a field perpendicular to the longitudinal direction of the enclosure. If necessary, insulation may be interposed between the magnets and the enclosure to protect the magnets from excessive heat. Electrodes are located within the enclosure in contact with the Brayton working fluid, and wires extend from the electrodes to the exterior of the enclosure for tapping electricity.

In the MHD enclosure some, but not all, of the kinetic energy of the MHD working fluid is converted into electrical energy. The gas stream leaving the MHD enclosure is still hot, and the heat of this gas can be transmitted, possibly using a heat pipe or pipes 36, to the heater 16 for heating the compressed Brayton Brayton working fluid. In this arrangement, electricity is produced both by the MHD system 37 as well by the alternator 12.

It is to be appreciated that the foregoing is a description of a preferred embodiment of the invention to which modifications and variations may be made without departing from the spirit and scope of the invention. For example, the entire apparatus can be mounted on top of the receiver 28 at the focal point of the collector. In order to upwardly scale the (electrical generating capacity of the solar energy conversion system, the solar receiver may employ a solar furnace to heat the Brayton working fluid.

What is claimed is:

1. Apparatus for converting solar energy to electrical energy comprising
a rotatable shaft,
a compressor coupled to said shaft for rotation therewith,
a turbine coupled to said shaft for rotation therewith,
an electric generator coupled to said shaft,
a compressible Brayton working fluid,
a compressible Brayton working fluid heating station,
a solar receiver for receiving solar radiation for heating said Brayton working fluid at said heating station,
a heating station-turbine conduit operatively connected between said heating station and said turbine,
a turbine-compressor conduit operatively connected between said turbine and said compressor,
a compressor-heating station conduit operatively connected between said compressor and said heating station,
said compressible Brayton working fluid having a pressure which increases at said heating station thereby propelling said Brayton working fluid through said heating station-turbine conduit to said turbine to cause rotation of said turbine, said shaft and said compressor, said heated Brayton working fluid thereafter passing from said turbine to said compressor through said turbine-compressor conduit where the pressure of said Brayton working fluid is increased and said Brayton working fluid is propelled through said compressor-heating station conduit back past said heating station whereafter said Brayton working fluid is continuously recirculated to drive said turbine and said shaft for causing said generator to produce electrical energy.

2. Apparatus for converting solar energy to electrical energy according to claim 1 further comprising a first heat exchanger including portions of said turbine-compressor conduit and said compressor-heating station conduit in mutual heat transfer proximity, the portion of said compressor-heating station conduit within said first heat-exchanger receiving heat transferred from the Brayton working fluid within the portion of the turbine-compressor conduit within said first heat exchanger for preheating said Brayton working fluid before it passes said heating station.

3. Apparatus for converting solar energy to electrical energy according to claim 1 wherein said solar receiver comprises a collector with a focus and said heating station is disposed at said focus.

4. Apparatus for converting solar energy to electrical energy according Lo claim 2 wherein said heating station comprises a heater which is heated by solar energy received at said solar receiver.

5. Apparatus for converting solar energy to electrical energy according to claim 4 comprising a heat pipe mounted between said solar receiver and said heater for efficiently transferring heat from said solar receiver to said heater.

6. Apparatus for converting solar energy to electrical energy according to claim 1 wherein said turbine-compressor conduit comprises a second heat exchanger disposed between said first heat exchanger and said compressor for transferring heat from said Brayton working fluid after said Brayton working fluid exits said first heat exchanger and before said Brayton working fluid enters said compressor.

7. Apparatus for converting solar energy to electrical energy according to claim 6 further comprising a blower for blowing air across said second heat exchanger to enhance heat transfer from said Brayton working fluid.

8. Apparatus for converting solar energy to electrical energy according to claim 1 wherein said heating station-turbine conduit comprises a bypass loop containing a cooling gas having a temperature lower than the temperature of said Brayton working fluid between said heating station and said bypass loop, a temperature sensor for sensing the temperature of said Brayton working fluid exiting said heating station, and a valve operatively connected to said temperature sensor for metering said cooling gas into said Brayton working fluid for maintaining the temperature of the Brayton working fluid below an acceptable limit.

9. Apparatus for converting solar energy to electrical energy according to claim 1 wherein said Brayton working fluid comprises a fluid selected from a group of fluids consisting of argon, carbon dioxide, nitrogen, helium, xenon, and krypton.

10. Apparatus for converting solar energy to electrical energy according to claim 1 wherein one of said turbine-compressor conduit and said compressor-heating station conduit is disposed within the other of said turbine-compressor conduit and said compressor-heating station conduit at said first heat exchanger

11. A method of converting solar energy to electrical energy comprising the following steps:
a. coupling a compressor, a generator, and a turbine capable of being driven by a Brayton working fluid for enabling rotation of said turbine to operate said compressor and said generator, said generator producing electricity in response to operation thereof,
b. deriving heat from solar radiation,
b. applying said heat derived from said solar radiation to a Brayton working fluid compressed by said compressor to heat said Brayton working fluid,
c. applying said heated compressed Brayton working fluid to said turbine for causing rotation of said turbine as said Brayton working fluid is spent,
d. applying said spent Brayton working fluid from said turbine to said compressor for compressing said spent Brayton working fluid, and
e. performing steps b, c and d repeatedly to recirculate said fluid through said turbine to operate said compressor and said generator, for causing said generator to produce electricity.

12. A method of converting solar energy to electrical energy according to claim 11 comprising applying said heat derived from solar radiation to one end of a heat pipe, said heat pipe conducting said heat derived from solar radiation to an end of said heat pipe opposite said one end, and passing said fluid from said compressor to said turbine past said end of said heat pipe opposite said one end to heat said Brayton working fluid.

13. A method of converting solar energy to electrical energy according to claim 10 further comprising passing said Brayton working fluid from said turbine through a first conduit in a first heat exchanger before said Brayton working fluid is applied to said compressor, and passing said Brayton working fluid from said compressor through a second conduit in said first heat exchanger before said Brayton working fluid is heated, said first conduit and second conduit being in heat transfer proximity within said first heat exchanger for preheating said Brayton working fluid before it enters said compressor.

14. A method of converting solar energy to electrical energy according to claim 13 further comprising passing said Brayton working fluid from said first heat exchanger through a second heat exchanger for further cooling said Brayton working fluid before said Brayton working fluid enters said compressor.

15. A method of converting solar energy to electrical energy according to claim 14 further comprising blowing ambient air about said second heat exchanger for transferring heat from said Brayton working fluid to said ambient air.

16. A method of converting solar energy to electrical energy according to claim 11 further comprising maintaining the temperature of said Brayton working fluid entering said turbine below an acceptable limit by continuously measuring the temperature of said Brayton working fluid before it enters said turbine, and in response to the temperature of said Brayton working fluid exceeding said acceptable limit, mixing with said Brayton working fluid a cooling gas having a temperature lower than the temperature of said Brayton working fluid.

17. A method of converting solar energy to electrical energy according to claim 11 further comprising applying at least a portion of said heat derived from said solar radiation to a magnetohydrodynamic working fluid in a magnetohydrodynamic power generator and transferring heat from said magnetohydrodynamic fluid to said compressed Brayton working fluid.

18. Apparatus for converting solar energy to electrical energy comprising
a compressible Brayton working fluid,
a compressor having an inlet for receiving said compressible Brayton working fluid and an outlet at which said compressible Brayton working fluid exits as a compressed Brayton working fluid,
a turbine having a fluid inlet in fluid communication with said compressor outlet for receiving said compressed Brayton working fluid therefrom, and a fluid outlet,
a solar collector for directing heat from solar radiation to said compressed Brayton working fluid for heating said compressed Brayton working fluid flowing from said compressor outlet toward said turbine inlet, and
a generator coupled to said turbine for producing electricity in response to the expansion of said compressed Brayton working fluid in said turbine, said turbine outlet being in fluid communication with said compressor inlet for returning expanded Brayton working fluid from said turbine to said compressor inlet.

19. Apparatus for converting solar energy to electrical energy according to claim 18 comprising a heat exchanger including a first conduit connected between said compressor inlet and said turbine outlet, and a second conduit connected between said compressor outlet and said turbine inlet, said first conduit being in heat transfer proximity to said second conduit whereby said compressed Brayton working fluid passing from said compressor outlet is preheated before being heated by said solar collector.

20. Apparatus for converting solar energy to electrical energy according to claim 18 wherein said solar collector comprises a magnetohydrodynamic power generator having a magnetohydrodynamic working fluid heated by said solar radiation, whereby heat emitted by said magnetohydrodynamic working fluid is transferred to said Brayton working fluid and electricity is produced by said generator and said magnetohydrodynamic power generator in response to said solar radiation.
